(19) United States
(12) Patent Application Publication
(10) Pub. No.: US 2022/0349829 A1
(43) Pub. Date: Nov. 3, 2022

(54) SENSOR AND FLOW CELL

(71) Applicant: Custom Sensors & Technology, Fento, MO (US)

(72) Inventors: Richard Nordman, St. Charles, MO (US); Mike Ponstingl, Sunset Hills, MO (US); Frank Westwood, Maplewood, MO (US)

(21) Appl. No.: 17/733,126

(22) Filed: Apr. 29, 2022

Related U.S. Application Data
(60) Provisional application No. 63/181,705, filed on Apr. 29, 2021.

(51) Int. Cl. G01N 21/85; G01N 21/31; G01N 21/64

(52) U.S. Cl. CPC G01N 21/85; G01N 21/31; G01N 21/64

(57) ABSTRACT

Sensor systems, and flow cells for use with them, which can provide for a universal sensor housing. The senor housing includes a first section which is designed to remain statically in position and a selectable sensor head that may be swapped out as necessary. The specific head is selected based on the types of measurement to be performed at the sensor location and the sensor head can integrate with the housing so only a single wire connection needs to be made to obtain all data from the housing.

### CROSS REFERENCE TO RELATED APPLICATION(S)

This Application claims the benefit of U.S. Provisional Patent Application 63/181,705 filed Apr. 29, 2021, the entire disclosure of which is herein incorporated by reference.

### BACKGROUND

### 1. Field of the Invention

This disclosure relates to flow cells and sensors for use with flow cells for a variety of flow testing applications. The flow cells are generally intended to be single use, and are used with a system including an interchangeable sensor head. The head and cell combination allows for specific selection of a desired input which can then be used to perform testing on the fluid in the flow cell.

### 2. Description of the Related Art

There are a number of places where material production or other activity creates what is effectively a process stream. Continuous manufacturing techniques as well as processes which are continuously acting on elements create a near constant output of end product that is in the form of a fluid (either liquid or gas). An example of this is water purification where an essentially continuous stream of impure water is taken in and an essentially continuous output of cleaner water is generated. This can be, for example, where water needs to be treated prior to its use in a process to provide process efficiency or in the treatment of wastewater streams. Another area is in bioprocess fluid streams used in the manufacture of biological materials. In fact, many activities in chemical, petro-chemical, pharmaceutical, waste processing, food, and beverage manufacturing process, among many others, involve the monitoring of process streams.

In these continuous processes, it should be recognized that continuous or near-continuous monitoring of the process is valuable. In upstream monitoring, it is typically important to determine an input composition of the stream to effect correct treatment. For example, in waste treatment not all wastewater streams fed into a cleaning process or system have identical properties and depending on the nature of the waste stream input, the treatment process may need to be altered to accurately clean the stream. As a still further example, source water for a manufacturing process may include naturally occurring contaminants in different amounts based on time and source and these streams need to be treated with chemicals to remove the impurities present to safe levels before the water is used to avoid buildup or damage to downstream devices.

The process stream downstream of a cleaning or manufacturing process also often requires monitoring. In this case, the monitoring is typically to determine if an upstream process acted as expected. For example, in bioprocess fluid streams, monitoring of the downstream fluid is often performed to provide indications of when an upstream filter is beginning to fail and undesirable materials are not being cleanly filtered out.

Failure to accurately measure the composition of the stream in any of these cases can result in a failure to detect a failing component or other process upstream resulting in a potentially dangerous stream being accepted. Similarly, a waste stream may be monitored after treatment to insure that the stream is within acceptable parameters before being discharged. As this last example shows, it is, therefore, also possible to monitor both upstream and downstream of the same process stream. Further, in manufacturing processes, downstream monitoring is often used to indicate that an upstream process is producing the intended output.

In both upstream and downstream applications, the addition of too much or too little treatment chemicals, or the use of inaccurate processes for the stream composition, can produce process inefficiency and a potentially undesirable or dangerous resultant product stream. Inefficiencies can include issues such as, but not limited to, the economic waste of valuable treatment chemicals, not removing a desired amount of the target before discharge or use resulting in potential downstream problems, or requiring excess time of the process stream in treatment slowing the manufacturing process which is dependent on the stream. In many cases involving chemical additive treatment, adding too much additive can also create a new problem downstream as the excess additive may itself result in buildup or damage to downstream processes, excess treatment further downstream to remove the additive, or a need for a further treatment process downstream that could otherwise be eliminated.

In manufacturing processes, if a downstream output is of unexpected composition, use of that output to generate commercial product can also be problematic. This is the case, for example, in the manufacture of pharmaceuticals. In this type of manufacturing process the process stream needs to have a correct ratio of active ingredient(s) to fillers so that packaging (for example in individual tablets, capsules, or liquid vials) leads to each package having a correct amount of active ingredient and each dose of the pharmaceutical is safe and effective. Such accuracy is also necessary in other types of manufacturing. For example, it is highly useful in bio-processing applications as well as things as simple as food production to ensure quality of product.

In all these cases, the ability to continuously and accurately monitor the composition of the process stream in order to accurately determine what it contains can be valuable. In downstream monitoring, should the end product not meet expectations, the processes upstream may be altered, potentially on the fly (for example, temperatures can be lowered, residence times in various phases can be increased, amounts of chemicals added can be increased or decreased, or filters may be swapped out), to provide for slightly different manufacturing parameters to make sure that the desired output is obtained. Similarly, in upstream detection, detected changes to inputs can result in changes, again potentially on the fly, being made to processes downstream to improve output. Alternatively, changes in composition may indicate wear or failure of upstream components which will need to be replaced with the process halted. However, these can be more accurately predicted and planned for when their impact is readily detected.

Due to the underlying process stream being an essentially continuous flow, the monitoring of the process stream is also preferably continuous and, so long as the monitoring operation itself does not require the addition of any materials to the process stream, it often can be. In many process streams, the monitoring and stream are continuous within a batch, but may be batch specific. This can be to allow for production of multiple products on the same manufacturing line and for various quality and testing requirements that may take place between batches.

One fairly common form of continuous monitoring is the use of light in spectrometry or photometry applications. While both can be performed in a batch setting, so long as an input light source can shine through the process stream, or a segregated portion of the process stream, they can be performed generally continuously on the stream so long as output processing from the sensor has sufficient speed. Thus, they can effectively monitor a stream in real-time or near real time. As modern computers typically can process sensor results in real-time or near real-time, this form of continuous monitoring can provide for very quick feedback. Thus, a concern can be quickly detected with the composition of the target stream. Basically, the monitoring knows acceptable parameters and when the stream gets outside the parameters, alerts can be triggered or changes can be made automatically by the computer or other processor to the associated processes.

Optical monitoring is typically performed through the use of a flow cell. A flow cell is effectively a hollow device having a relatively small volume that the process stream, or a portion of the process stream, will pass through. This volume is positioned inside an enclosure (which effectively forms the flow cell) and the flow cell has connectors to couple the sensor to liquid or gas handling components to provide the continuous samples of the process stream. The cell is also coupled via light handling connectors to a light source to allow light to pass through the sample in the flow cell. The output light is then monitored by a processor to determine the relevant composition of the process stream. This monitoring may occur autonomously or semi-autonomously, or the output may be directed to an indicator which is monitored by a human operator.

While using photometry and spectrometry techniques can be particularly useful in process stream monitoring, monitoring other characteristics of the stream can also be desirable and other connectors and sensor components may also be present in the process stream. For example, sensor probes that can detect acidity (pH), turbidity (NIR), conductivity, temperature, and pressure may be included. An example of a flow cell is provided in U.S. Pat. No. 9,285,250, the entire disclosure of which is herein incorporated by reference.

While sensors for any or all of the above may be present, photometry and spectrometry are particularly useful testing methods when it comes to flow cells. As both systems typically utilize light absorption by the sample, it is relatively easy to place the sample in the cell at an instant where it can be penetrated by light of the wavelengths of interest allowing the incoming light to be projected into the cell, through the sample, and outgoing light to be collected. This allows for the sample to be completely separated from the testing equipment so that the testing equipment can be disconnected, modified or replaced without the need to ever disturb the material in the flow cell, or the process stream. Further, the sample is not held in the flow cell, but is simply interrogated as it passes through the cell, and the sample is only typically interacted with by the light source, which is generally contactless and posses little risk of contamination.

While flow cells are excellent for performing process measurements, one concern associated with their use is their generally single use nature and their lack of ability to integrate multiple types of testing. These types of devices often comprise only a single sensor and each is specific for the type of analysis it performs. For example, a spectrometry cell will typically include only components for a spectrographic measurement. Other types of sensors such as pressure sensor are often different constructed and will only include elements necessary for a pressure measurement. This often leads to a proliferation of sensors both upstream and downstream if a variety of parameters of the process stream need to be known.

As an example, FIG. 1 shows a simple formulation and filing process (10) comprising mixing ingredients in a mixer (41), pumping (43) the material through a filter (44), collecting the filtered material (45), and dispensing it into containers (47). This type of process could easily be present in a food manufacturing process or in a pharmaceutical manufacturing process. The process shown in FIG. 1 utilizes six separate sensors (11), (13), (15), (21), (23) and (31) at various points in the process. However, as can be seen, the sensors (11), (13), (15), (21), (23) and (31) are positioned to act at similar times on the stream. For example, three sensors including temperature (11), conductivity (13), and UV light interrogation (15) operate between the mixer (41) and the pump (43) to monitor the composition of the mixer (41) output. Meanwhile, two sensors, including the flowmeter (21) and pressure sensor (23), operate between the pump (43) and the filter (44) to verify that the stream is being mechanically presented to and through the filter (44) in an expected manner. Finally the final pressure sensor (31) operates after the storage vessel (45) and immediately prior to filling (47) to verify that the final containers are filled the correct amount. It should be recognized that many of these functions could be provided in a single sensor device if the various sensing methodologies were incorporated together. For example, a single sensor performing light measurement, conductivity, and temperature measurements could replace sensors (11), (13), and (15).

While FIG. 1 gives a simple example, particularly in bio processing applications, sensors and flow cells are typically of single use. That means that the components of the cell which are in direct contact with the process stream are commonly only used for a single run of a process, at which point they are removed and replaced with fresh cells. The use of single use cells which are only capable of a single type of measurement can create a major organizational problem. In particular, the need to stock so many different types of cells and to make sure they are put into the correct sensors can be difficult. Further interconnection of the cells to monitoring computers and other apparatus can also involve a maze of cables which are regularly being connected and disconnected.

Recently, there has been a push to combine sensors into a single cell where the cell can be used to obtain multiple forms of measurement at a single point in the process stream. In theory, this should simplify data collection and logistics as a single device can be used in place of multiple devices. In practice, these device, however, are often complicated and still require multiple cables coming from the same device to carry the disparate signals. Further, it is the case with disposable cells, that cells can be put in incorrect sensors so that a sensor which is expecting a certain type of attached cell with certain attached elements suddenly does not have what is expected and cables regularly need to be connected and disconnected when cells are replaced creating the possibility of interconnecting the cell incorrectly.

### SUMMARY

The following is a summary of the invention in order to provide a basic understanding of some aspects of the invention. This summary is not intended to identify key or critical elements of the invention or to delineate the scope of the invention. The sole purpose of this section is to present some concepts of the invention in a simplified form as a prelude to the more detailed description that is presented later.

Because of these and other related problems in the art, described herein, among other things, are sensor systems, and flow cells for use with them, which can provide for a universal sensor housing. The senor housing includes a first section which is designed to remain statically in position and a selectable sensor head that may be swapped out as necessary. The specific head is selected based on the types of measurement to be performed at the sensor location and the sensor head can integrate with the housing so only a single wire connection needs to be made to obtain all data from the housing. Further the sensor head and flow cell can be swapped out without needing to disconnect the sensor from attached cabling.

There is described, in an embodiment, a sensor system comprising: a lower housing including a flow cell mount and a measurement photodiode; a sensor head including a light source and an array of electrical contacts, the sensor head connected to the lower housing so as to provide a space between the lower housing and the sensor head; and a flow cell, the flow cell positioned within the space between the sensor head and the lower housing, the flow cell attached to the flow cell mount and the flow cell including: a generally hollow elongated main body including connectors arranged toward the opposing ends thereof, the connectors configured to interconnect with corresponding connectors in a process stream transport structure to allow at least a portion of a process stream to flow through the hollow interior; a sensor chip which is in electrical contact with the electrical contacts in the sensor head; and a light access comprising opposing windows which allow light from the light source to pass through the hollow interior and to the measurement photodiode.

In an embodiment, the system further comprises: a pH probe electrically connected to the sensor head and mounted in a probe housing in the flow cell to detect pH in the hollow interior.

In an embodiment of the system, the sensor chip includes sensors for measuring at least one of: conductivity, temperature, or pressure in the hollow interior.

In an embodiment of the system, the light access is configured for absorption photometry in the hollow interior.

In an embodiment of the system, the light access is configured for front surface fluorescence.

In an embodiment of the system, the light access is configured for spectroscopy in the hollow interior.

In an embodiment of the system, the light access comprises two opposing windows in the main body

In an embodiment of the system, the windows are configured to be useable with a variety of optical path lengths varying from 0.5 mm to 100 mm, from 0.5 mm to 60 mm, from 0.5 mm to 50 mm, or from 0.5 mm to 10 mm.

In an embodiment of the system, each of the windows in subdivided into a plurality of sub-windows.

In an embodiment of the system, the sub-windows are arranged to provide for four separate light columns each having a different path length.

In an embodiment of the system, the light paths have a length of about 0.25 mm, about 0.50 mm, about 1.00 mm, and about 2.00 mm.

In an embodiment of the system, the flow cell mount comprises a rail and latch and the flow cell includes a groove for interacting with the rail and a pin for interacting with the latch.

In an embodiment of the system, the lower housing includes a connector for a remote device.

In an embodiment of the system, the remote device comprises a display.

In an embodiment of the system, the remote device comprises a computer.

There is also described herein, in an embodiment, a sensor system comprising: a lower housing including a flow cell mount and a measurement photodiode; and a sensor head including a light source and an array of electrical contacts, the sensor head connected to the lower housing so as to provide a space between the lower housing and the sensor head; wherein the lower housing and the sensor head are configured and positioned so a flow cell positioned within the space between the sensor head and the lower housing: attaches to the flow cell mount; and interconnects with a process stream transport structure to allow at least a portion of a process stream to flow through a hollow interior of the flow cell; wherein the flow cell includes a sensor chip configured to interconnect to the electrical contacts in the sensor head; and wherein light from the light source passes through the hollow interior and to the measurement photodiode.

There is also described herein, in an embodiment, a flow cell comprising: a generally hollow elongated main body including connectors arranged toward the opposing ends thereof, the connectors configured to interconnect with corresponding connectors in a process stream transport structure to allow at least a portion of a process stream to flow through the hollow interior; a sensor chip including electrical contacts for interconnecting with a sensor head; and a light access comprising opposing two opposing windows, each of the opposing windows including multiple sub-windows and allowing light from the light source to pass through the hollow interior.

In an embodiment of the flow cell, each of the sub-windows are arranged to provide for four separate light columns each having a different path length.

### BRIEF DESCRIPTION OF THE DRAWINGS

FIG. 1 depicts an example of a formulation and filing application showing the location of multiple sensors.

FIG. 2 shows a front perspective view of a sensor with a single use flow cell installed in phantom.

FIG. 3 shows a rear perspective view of the sensor of FIG. 2.

FIG. 4 shows a perspective view of a first embodiment of a single use flow cell. This embodiment includes a single optical path, a direct access probe for pH measurement, and a drop-in cell for other measurements.

FIG. 5 shows a side view of a second embodiment of a single use flow cell. This embodiment includes multiple optical path columns with different path lengths and a drop-in cell for other measurements.

FIG. 6 shows the top view of the embodiment of FIG. 5.

FIG. 7 shows an embodiment of a drop-in cell useable with the cells of FIGS. 4, 5, and 6 for pressure, temperature and conductivity measurement.

FIG. 8 shows a side view of an embodiment of an alignment tool for aligning the optical path columns of FIG. 5.

FIG. 9 shows a top view of the embodiment of FIG. 8.

FIG. 10 shows the sensor of FIGS. 2 and 3 with the sensor head separated from the body to illustrate the electrical connection for different types of sensor heads.

FIG. 11 shows the sensor of FIGS. 2 and 3 with the housings removed and with the details of light transmission systems visible to provide for a sequential absorbance measurement.

FIG. 12 shows the sensor of FIGS. 2 and 3 with focus on the locking mechanism for attaching the cell.

FIG. 13 shows a rear view of FIG. 12 illustrating the release lever.

FIG. 14 shows the sensor of FIGS. 2 and 3 with a reference filter in place.

FIG. 15 shows the sensor of FIGS. 2 and 3 with a simulator positioned in place of a cell.

### DESCRIPTION OF PREFERRED EMBODIMENT(S)

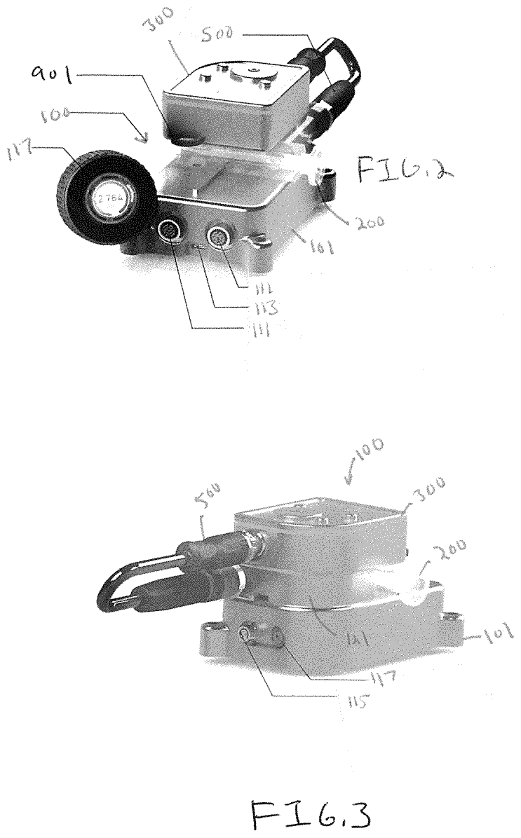

FIGS. 2 and 3 provide for a general overview of an embodiment of a flexible sensor system (100). The sensor system (100) comprises two major components. There is a lower housing (101) which typically serves to provide a mount for the flow cell (200) (shown in phantom) and a sensor head (300).

The flow cell (200) is typically constructed to include a variety of sensor hardware which allows it to perform multiple types of measurements. The flow cell (200) can communicate with the sensor head (300) to make sure that the measurements the sensor head (300) intends to have performed have corresponding hardware in the flow cell (200) so that desired measurements are correctly performed and sensor heads (300) and flow cells (200) are correctly paired. This will be discussed in greater detail later.

The lower housing (101) is typically designed to be positioned and remain in place in the process stream. As such it will typically include a plurality of signal connectors for attachment of a variety of different connections and will typically act as a transmitter for the system (100). The ports for interconnection can include any connection port known know or later developed including, but not limited to, standard wire input/output connectors (111), a Universal Serial Bus (USB) connector (113), and a visual output connector (115) for connection to a display (117). Often, the ports (111), (113), and (115) will be designed for interconnection to a computer or similar device.

The term “computer” as used herein describes hardware which generally implements functionality provided by digital computing technology, particularly computing functionality associated with microprocessors. The term “computer” is not intended to be limited to any specific type of computing device, but it is intended to be inclusive of all computational devices including, but not limited to: processing devices, microprocessors, personal computers, desktop computers, laptop computers, workstations, terminals, servers, clients, portable computers, handheld computers, cell phones, mobile phones, smart phones, tablet computers, server farms, hardware appliances, minicomputers, mainframe computers, video game consoles, handheld video game products, and wearable computing devices including, but not limited to eyewear, wristwear, pendants, fabrics, and clip-on devices.

As used herein, a “computer” is necessarily an abstraction of the functionality provided by a single computer device outfitted with the hardware and accessories typical of computers in a particular role. By way of example and not limitation, the term “computer” in reference to a laptop computer would be understood by one of ordinary skill in the art to include the functionality provided by pointer-based input devices, such as a mouse or track pad, whereas the term “computer” used in reference to an enterprise-class server would be understood by one of ordinary skill in the art to include the functionality provided by redundant systems, such as RAID drives and dual power supplies.

It is also well known to those of ordinary skill in the art that the functionality of a single computer may be distributed across a number of individual machines. This distribution may be functional, as where specific machines perform specific tasks; or, balanced, as where each machine is capable of performing most or all functions of any other machine and is assigned tasks based on its available resources at a point in time. Thus, the term “computer” as used herein, can refer to a single, standalone, self-contained device or to a plurality of machines working together or independently, including without limitation: a network server farm, “cloud” computing system, software-as-a-service (SAAS), or other distributed or collaborative computer networks.

Those of ordinary skill in the art also appreciate that some devices which are not conventionally thought of as “computers,” nevertheless exhibit the characteristics of a “computer” in certain contexts. Where such a device is performing the functions of a “computer” as described herein, the term “computer” includes such devices to that extent. Devices of this type include, but are not limited to: network hardware, print servers, file servers, NAS and SAN, load balancers, and any other hardware capable of interacting with the systems and methods described herein in the matter of a conventional “computer.”

A “computer” will typically utilize “software” in it's functioning. “Software” as used herein refers to code objects, program logic, command structures, data structures and definitions, source code, executable and/or binary files, machine code, object code, compiled libraries, implementations, algorithms, libraries, or any instruction or set of instructions capable of being executed by a computer processor, or capable of being converted into a form capable of being executed by a computer processor, including, without limitation, virtual processors, or by the use of run-time environments, virtual machines, and/or interpreters.

Those of ordinary skill in the art recognize that software can be wired or embedded into hardware, including, without limitation, onto a microchip, and still be considered “software” within the meaning of this disclosure. For purposes of this disclosure, software includes, without limitation: instructions stored or storable in hard drives, RAM, ROM, flash memory BIOS, CMOS, mother and daughter board circuitry, hardware controllers, USB controllers or hosts, peripheral devices and controllers, video cards, audio controllers, network cards, Bluetooth® and other wireless communication devices, virtual memory, storage devices and associated controllers, firmware, and device drivers. The systems and methods described here are contemplated to use computers and computer software typically stored in a computer- or machine-readable storage medium or memory.

The lower housing (101) may also include, in an embodiment, wireless transmission capability. The lower housing (101) will typically be interconnected with displays, computers, analytical engines, or other processors, storage, computing devices, or machines, that can utilize the output of the sensor (100) elsewhere. This will typically be for monitoring of the process stream, but the system (100) may also be connected with machines which can react autonomously on the stream based on the output of the system (100). In FIG. 2, the display (117) is depicted in proximity to the lower housing (101), this is by no means required and the display (117) will typically not be near to or connected to the lower housing (101) but will be positioned anywhere it is convenient such as in a quality control office.

The lower housing (101) may also include a tare/zero/or reset button (117) which can be used to reset the sensor in the event of a problem or to restart the sensor system (100) upon installation of a new flow cell (200) and/or sensor head (300). The display (117) in an embodiment, can provide displays of measurements and/or calibration information while the various other connections can be used to provide for proprietary software, alarm relays, or data offload. The lower housing (101) may also include a memory and processor for onboard data logging and related functions.

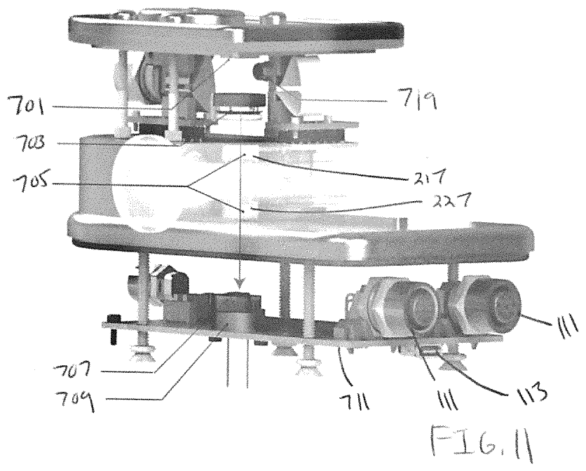

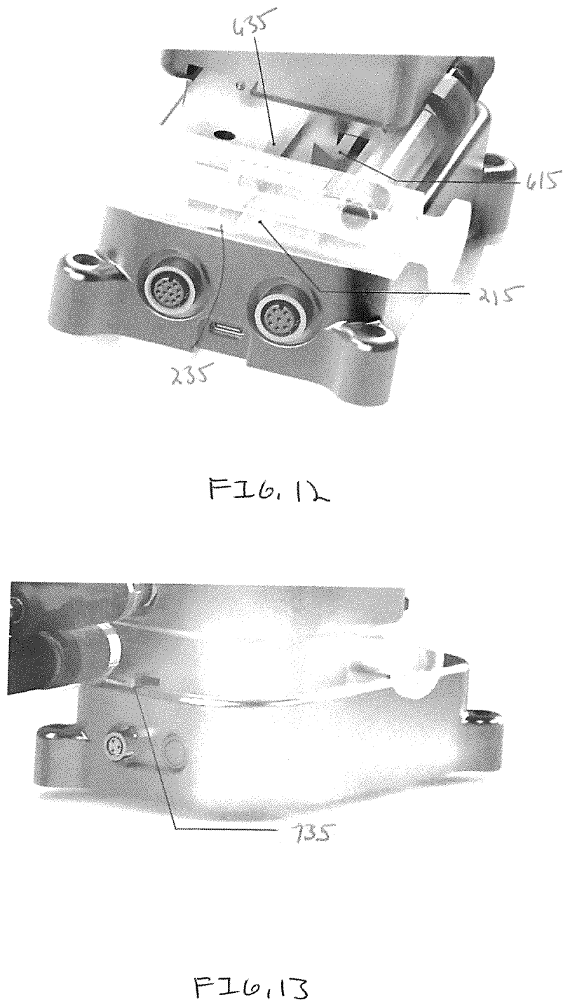

Interconnection of the sensor head (300) to the lower housing (101) is discussed in more detail in conjunction with FIG. 10, but the lower housing (101) will typically include a shoulder (121) that acts to hold the sensor head (300) in a manner that the sensor head (300) is positioned spaced from the primary body of the lower housing (101) with the main body (201) of the flow cell (200) being positioned between the lower housing (101) and the sensor head (300). In the event that the sensor head (300) is going to be used for acidity (pH) measurements, a pH probe and connection cable (500) may be interconnected between the sensor head (300) and the probe housing (203) of the flow cell (200). Sensor heads (300) may include a variety of components including, but not limited to, light sources (701) as discussed in conjunction with FIG. 11, pH, conductivity, temperature, and pressure monitoring circuitry depending on the desired functionality of a sensor head (300).

Sensor heads (300) are preferably interchangeable and a user may remove a single screw or other locking mechanism to disconnect any sensor head (300) from the lower housing (101) without need to move the lower housing (101) or disconnect any cables from it. Each sensor head (300) will typically contain data storage for specific sensor head parameters and data logging. It should be recognized that with the use of interchangeable heads (300), should a head become damaged, it may be removed and replaced without needing to replace the lower housing (100) or disconnect the system (100) from any cables or remote monitoring displays or devices.

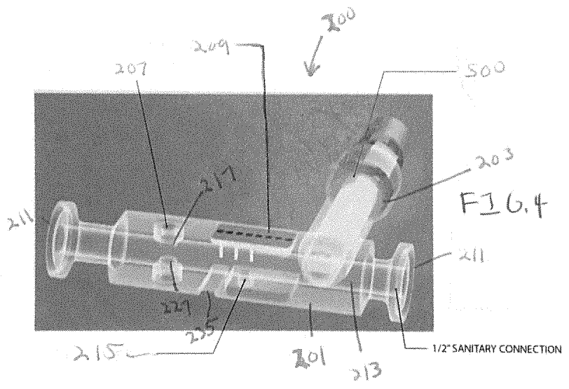

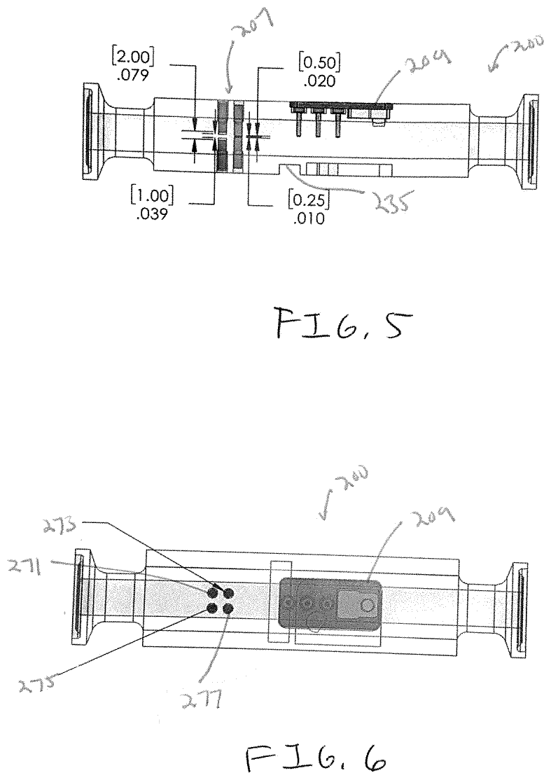

An embodiment of a flow cell (200) is shown in FIG. 4 with a modified version of a similar cell (200) shown in FIGS. 5 and 6. The flow cell (200) generally comprises a main body (201) and an auxiliary probe housing (203). The main body (201) comprises a generally hollow elongated structure which is typically cylindrical in shape. There are connectors (211) arranged at the opposing ends of the main body (201) which are designed to interconnect with corresponding connectors in the process stream transport structures. This allows the process stream, or a portion of the process stream, to flow through the hollow interior (213) of the main body (201).

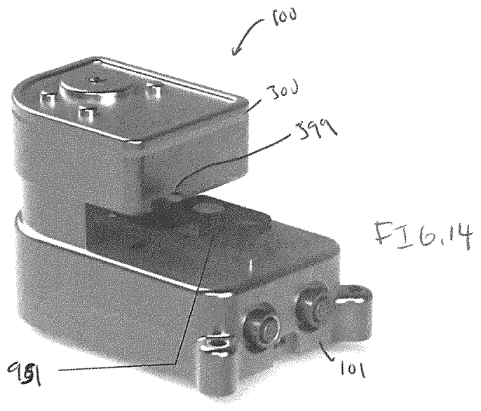

On the underside of the flow cell (200), there is a locking element (215) which may comprise a pin or a void. There is also a channel (235) for alignment of the flow cell (200) with the lower housing (101). The locking element (215) is configured to be repeatedly removably engaged by a corresponding locking element (615) on the lower housing (101). This will be discussed in greater detail in conjunction with FIGS. 12 and 13 later in this disclosure.

The probe housing (203) will generally serve to support the pH probe (500) in a manner that allows it to extend into contact with the hollow interior (213) so as to allow the pH probe to measure the pH of the stream within the hollow interior (213). It should be recognized that the probe housing (203) in the depicted embodiment is designed to house a pH probe of particular, but typically common, shape. Specifically, in the embodiment of FIG. 4 it is designed to house a Hamilton SU Probe. However, in alternative embodiments, the probe housing (203) may be of different shape, configuration, or positioning depending on the shape of the pH probe (500) it is intended to support.

The flow cell (200) will typically be constructed from regulatory compliant materials for its intended operational environment. It will also preferably be cleanable and/or sterilizable and may be designed to be compatible with gamma irradiation and/or autoclaves. The cell (200) in the depicted embodiment may be constructed of Nylon 12 and/or polysulphone and may be formed by any manufacturing process currently known or later developed.

In order to provide for a variety of different sensing options, in addition to the probe housing (203) being configured to support a pH probe (500), the flow cell (200) includes two other access points for sensors. These are the mount for a sensor chip (209) and the windows for light access (207). In order to be useable in a variety of different applications the connectors (211) may be of any desired type, style, or means including, but not limited to, sanitary connections, barbed connections, or compression connections.

FIGS. 4, 5, and 6 provide for additional detail on the light access (207). The light access (207) generally comprises two opposing windows (217) and (227) which allow light of particular wavelength(s) (which may be any or all wavelengths) to pass from one side of the cell (200) to the other through the hollow interior (213). The windows (217) and (227) will typically allow for absorption photometry in addition to or instead of other light-based measurement techniques including, but not limited to, spectroscopy. The windows (217) and/or (227) may also be configured for fluorescence measurements including, but not limited to, front surface fluorescence.

In the depicted embodiment of FIG. 4 the windows (217) and (227) are designed to be interchangeable to allow for the use of a variety of optical path lengths as would be known to one of ordinary skill in the art. In an embodiment, these path lengths can vary from 0.5 to 100 mm, 0.5 to 60 mm 0.5 to 50 mm, or 0.5 to 10 mm depending on the type of measurement desired. As an example, cells to measure turbidity will often be designed primarily for about 60 mm path lengths.

In the embodiment of FIG. 4, the windows (217) and (227) are each a single window. This can be desirable if only a single path length is desired with the cell (200) in any one use. As contemplated above, the path length can still be alterable between cells (200) or even between multiple uses of the same cell (200) if such a cell (200) was not intended to be for single-use application as can be the case in some embodiments. The cell (200) as depicted in FIGS. 5 and 6, however, is designed to provide for multiple path lengths in a single cell (200) at the same time.

In the cell (200) of FIGS. 5 and 6, each window (217) and (227) is actually subdivided into four smaller sub-windows. These sub-windows are then arranged to provide for four separate light columns (271), (273), (275) and (277). Each of the light columns (271), (273), (275) and (277) provides a window pair with a different path length. The use of four columns is by no means required and any number may be included. Further, it is also not required that the pathlengths be different and multiple pathlengths that are generally the same may be provided in the same cell. As illustrated in FIG. 6, the path length of column (271) may be 0.25 mm, the path length of column (273) may be 0.50 mm, the path length of column (275) may be 1.0 mm, and the path length of column (277) may be 2.0 mm. The inclusion of multiple path lengths allows for the sensor head (300) to utilize one or more light sources to supply light to each of the separate columns. This can allow for use of different path lengths by the sensor (100) either at different times (for example, the selected column may be changed if an increase or decrease in a compound of interest is detected) or to perform different measurements at the same time.

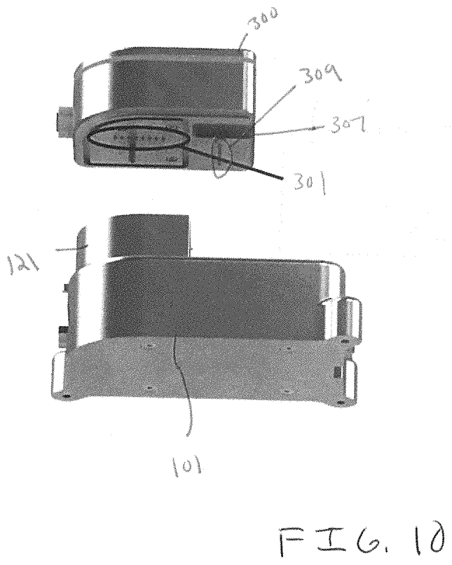

In order to position the columns (271), (273), (275) and (277) accurately in each cell, a positioning tool (600) as shown in FIGS. 8 and 9 may be used. The positioning tool (600) includes a handle (601) for manipulation of the tool (600). The handle (601) will typically be of greater diameter than the diameter of the hollow interior (213) so that the tool (600) can utilize positioning of the handle (601) against the main body (201) as part of its positioning. The tool will also include a penetration section (603) which is generally of similar diameter to the diameter of the hollow interior (213). The penetration section (603) will, therefore, typically be positioned within the connector (211) on the left side of the cell (as viewed in FIGS. 5 and 6) and will extend into the hollow interior to a position just shy of the location of the columns (271), (273), (275) and (277). Positioning this deeply into the hollow interior is performed by having the handle (601) abut the connector (211) when correctly positioned. As the penetration section (603) is of similar diameter to the hollow interior (213), the tool (600) will typically also self-center within the hollow interior (213).

At the far end of the tool (600) from the handle (601) is a positioning plate (605). The positioning plate (605) comprises four sub-plates (651), (653), (655) and (657). These sub-plates are generally arranged so as to share a center line in their width with a center line through the penetration section (603) (which passes through the central axis of the penetration section(603)). The plate (605) and each of the sub-plates (651), (653), (655) and (657) will, thus, typically extend from one side of the hollow interior (213) to the other passing through the axis of the hollow interior (213) with a plane positioned through the center (width) of each of the sub-plates (651), (653), (655) and (657). The widths of each sub-plate correspond to the desired path length of the corresponding column. Thus, each of the sub-plates (651), (653), (655) and (657) has, in corresponding order, a width equal to the path length of the columns (271), (273), (275) and (277).

As should be apparent, to position the windows to form the columns (271), (273), (275) and (277), one simply inserts the tool (600) into the left hand connector (211) of the cell (200) until it can penetrate no further. One then will arrange the tool (600) so that the plate (605) is generally perpendicular to the line from the window (217) to (227). The various column components are then inserted until they contact the plate (605). If they are positioned under pressure from each of them, the plate (605) (and tool (600)) will typically rotate slightly until the plate (605) is positioned essentially perpendicular to them. The window components may then be adhered or otherwise maintained in place relative to the main body (200). As the thinner plates (653) and (657) are further into the cell (200), once the columns (271), (273), (275) and (277) have been formed and secured, the tool (600) may simply be withdrawn backwards from the connector (211) without catching on the columns (271), (273), (275) and (277).

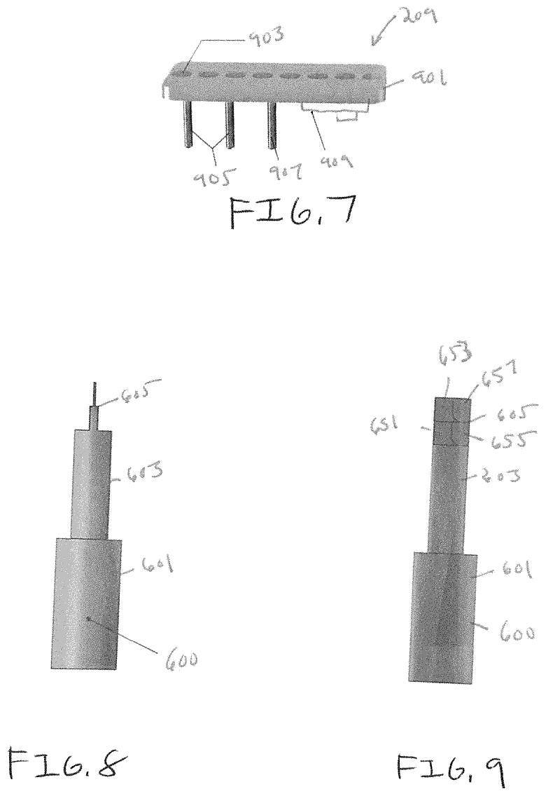

FIG. 7 provides for increased detail of the sensor chip (209) shown in FIGS. 4, 5, and 6. The sensor chip (209) typically comprises a generally planar circuit board (901) which is sized and shaped to press fit into a corresponding void in the main body (201) of the flow cell (200). The sensor chip (209) may be adhered in the corresponding void or may be held in place via friction or other methods. On the first, or top, side of the circuit board (901) forming the main structure of the sensor chip (209) there are arranged an array of electrical contacts (903) which are intended for interconnection to the sensor head (300) as discussed later. On the second or opposing bottom side of the circuit board there are arranged a plurality of probes which are intended to extend into the hollow interior (213) of the cell (200). These probes can include a pair of probes (905) designed to measure conductivity, a probe (907) designed to detect temperature, and/or a probe (909) designed to detect pressure. Once positioned, the probes (905), (907), and (909) will typically be within the hollow interior (213) where they can contact the process stream therein. The signals from the probes (905), (907) and (909) will then typically be sent to the electrical contacts (903) corresponding to the respective probe.

FIG. 10 shows greater detail of the connection points of the sensor head (300). The sensor head (300) will typically include an array of electrical contacts (301) such as, but not limited to, spring loaded pin (pogo) type connectors or flexible connectors. These will be positioned to correspond to electrical contacts (not visible) in the shoulder (121) of the lower housing (101). Typically, the positioning and selection of the contacts in the array (301) will correspond to the type of sensing the sensor head (300) is to be used for. Thus, the array will usually look different and have different available connectors for sensor heads (300) which are designed to provide different measurements. As should be apparent, the sensor head (300) will typically be sized and shaped on its lower surface to have a single orientation and positon which corresponds to the top of the shoulder (121). The sensor head (300) may be held in place on the shoulder through any system, means, or method known to one of ordinary skill in the art including, but not limited to, press fit (friction) connections, screws or bolts, locking mechanisms, or any combination thereof.

A second array (309) of electrical contacts is also provided on the sensor head (300). This second array (309) is designed to interconnect with the electrical contacts (903) on the circuit board (901). As with the first array (301), the specific positioning of the contacts in the second array (309) will typically correspond to the type of measurements that the sensor head (300) is designed to perform. The joint modification of the arrays (301) and (309) (or either one singly) can, thus, allow for a universally designed flow cell (200) having multiple measurement capabilities to only provide those desired by the sensor head (300) which is currently selected and in use. Thus, should the circuit board include, for example, a temperature probe (907) but it is undesirable for a specific head to obtain a temperature measurement, the array (309) can fail to include a connector in the second array (309) which would connect with the temperature probe (907) output connector (903). The first array (301) may then also not include a temperature output connector which would indicate that the sensor head (300) is not intended to obtain temperature measurements.

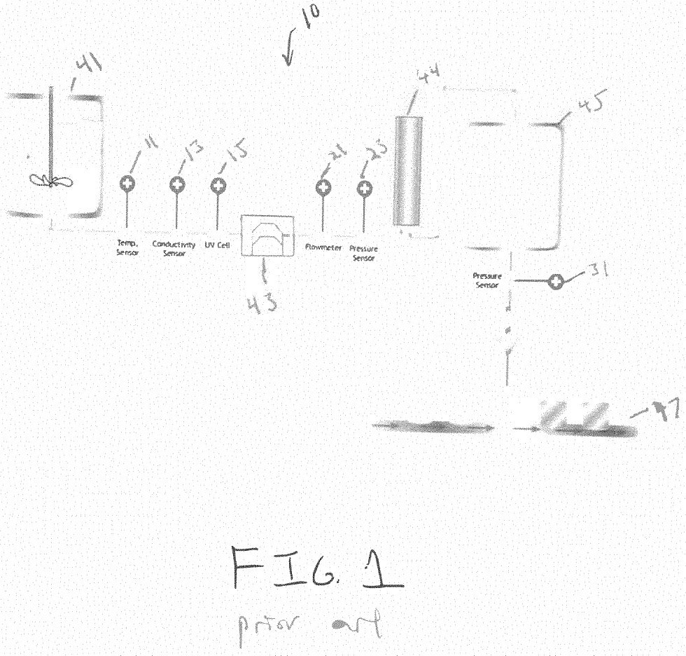

It should be apparent, that the use of such different arrays will provide an essentially endless selection of sensor heads (300) and cells (200) to allow for any individual sensor (100) to process a single measurement to all measurements available in any cell (200) as well as any desired sub combination. It should be further recognized that such an arrangement will actually allow for a universal sensor head (300) and/or universal flow cell (200) which includes the capabilities for performing all available measurements of any head (300) or cell (200) to be used in conjunction with every system (100), but with certain capabilities not used at any one location. For example, the cell (200) of FIG. 4 may be used to replace the sensors (11), (13) and (15) of FIG. 1 and/or to replace the sensors (21) and (25). As the cell (200) of FIG. 4 could include any or all of the sensors of both these locations.

In order to avoid concerns that a cell (200) may be used with an incompatible head (e.g. a cell with no temperature sensor (907) being connected to a head (300) which is intended to obtain a temperature measurement, indicators may be used to show when such a mismatch of components occurs. Specifically, the sensor head (300) may include systems, methods, or means for automatically determining that a new cell (200) has been inserted into it and to verify that the cell (200) can perform at least the functions the head (300) wants to perform. It should be recognized that the cell (200) may always be capable of performing extra measurements which the sensor head (300) simply does not use, in an embodiment. Upon detection of a cell (200) having been inserted (such as by having the pins in array (309) detect a connection), the head (300) may automatically calibrate the conductivity and pH sensors if it is using them.

In an embodiment, Radio Frequency Identification (RFID) or similar tags may be attached to each cell (200) and/or pH sensor (500). The tags will typically contain calibration coefficients that are determined at the factory for each unique sensor. When the cell (200) and or sensor (500) is to be used in a particular system (100), a user swipes the RFID tag on the cell (200) across a reader in the system (100) to automatically load a unique calibration for the specific cell (200) and/or sensor (500) that is being placed in the system (100). Alternatively, data may be provided to the system (100) by other means, such as, but not limited to, via a computer utilizing ports (111) to input data to the system (100). In addition to calibration data, the tag may also include data describing the specific sensors that are installed in the cell (200) as well as serial number and lot information. The system (100) may include a Red/Green/Blue (RGB) indicator and buzzer in the housing (101) and/or head (300) to provide visual/audible feedback to the user informing them of calibration success or failure at the system (100) itself, or such information may be provided via the display (117).

The flow cell (200) is fixed to the lower housing using a repeatedly removable connection method, system, and/or means. An embodiment of such a system is shown in FIGS. 12 and 13. In this embodiment, the flow cell (200) includes a channel (235) as illustrated in FIGS. 4 and 5. The lower housing (101) then includes a rail (635) corresponding to the channel (235). The flow cell (200) is positioned on the lower housing (101) with the rail (635) in the channel (235) and the cell (200) may be slid into the space between the lower housing (101) and sensor head (300) abutting the shoulder (121). At the correct position, a sliding spring-loaded latch mechanism (615) will detent around the pin (215) and then return to it's initial position latching the cell (200) in positon between the housing (101) and sensor head (300).

Upon latching the flow cell (200) in position, the pogo or similar contacts of array (309) will be in electric communication with the array (903) so that data from the conductivity (905), temperature (907), and pressure (909) sensors may be transmitted to the sensor head (300) from the cell (200). A lever (735) is located on the rear of the housing (101) which will cause the latch mechanism (615) to detent away from the pin (215) releasing the cell (200) and allowing the cell (200) to be removed.

FIG. 11 provides details of the internal components of an embodiment of the sensor head (300) and lower housing (101) illustrating how optical measurements may be performed. A head (300) intended for light measurements will typically include a light source (701). This will typically be solid state light source such as an array of Light Emitting Diodes (LEDs) and typically 1-4 LEDs may be installed. It should be apparent that when multiple columns (271), (273), (275) and (277) are present in the cell (200), there will often be one LED present for each column (271), (273), (275) and (277). This is, however, by no means required and a single LED may used as a source for multiple columns (271), (273), (275) and (277) or multiple LEDs may be used as a source for any single column. The LEDs may be used simultaneously, physically spaced, or temporally spaced to provide for a variety of measurements. In an embodiment, the LEDs may be illuminated in a fashion to allow for simultaneous, sequential, or patterned absorbance measurements at various wavelengths.

The light source (701) will typically be installed into the sensor head (300) at a position above the flow cell (200). Energy emitted from the light source (701) is passed through a lens (703) and then through a portion (705) of the sample inside of the flow cell (200) and between the windows (217) and (227). It then goes into the lower housing (101) and through a filter (707) (if desired) before contacting a measurement photodiode (709) or similar structure which will typically be mounted on a printed circuit board (711) along with other components of the lower housing requiring electrical connection such as the ports (111) and (113). A reference photodiode (719) in the sensor head (300) may be used to monitor the intensity and/or wavelengths of the light source (701) to account for any long-term decay and to reference thermal and electrical noise. The optional filter (707) may be installed to provide a band pass or similar filtration, if required.

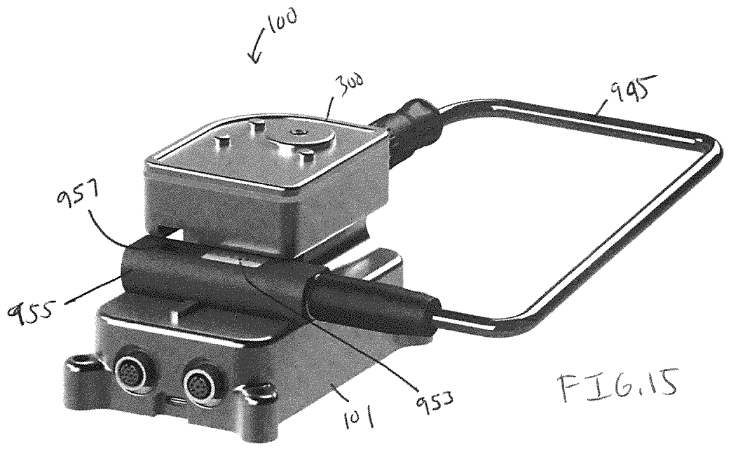

FIG. 14 provides for an embodiment of the sensor (100) with the flow cell (200) removed but including a filter (951). In the depicted embodiment of FIG. 14, the sensor head (200) would include light measurement capability and includes a slot (399) for holding a filter (951) which is shown spaced from the head (300) but aligned for insertion. FIGS. 2 and 3 actually show the filter (951) in place. The filter (951) will typically comprise a NIST traceable filter for insertion into the light path for photometric verification. The absorbance of each filter is typically determined on a qualified spectrometer. It should be recognized, however, that this type of filter (951) is simply one option and filter (951) may be selected to provide for any kind of calibration or verification purposes as would be understood by one of ordinary skill in the art. It may also be used to alter the light from light source (701) before it enters the flow cell (200) should that be desired.

FIG. 15 shows a still further form of calibration. In FIG. 15, the cell (200) has been replaced by a simulator (955) which will provide for simulated signals to the head (300). This may be used to calibrate the head (300), to verify proper function, and/or to validate the sensor's (100) performance for pH, conductivity, temperature, and/or pressure measurements. The simulator (955) will typically include a test array (953) which provides for similar electrical connections to array (903) but with the simulator (955) including high precision resistors, mV outputs, and other simulated signal hardware to simulate the response of the various sensors contained within a typical cell (200). Similarly, the connection (995) can be provided to simulate a pH meter output and a window (957) may be provided which can provide a simulated target for light measurement. An RFID tag or similar structure may be provided on or with the simulator (955) in the same manner as is done for a cell (200) as contemplated above which stores reference data that may be compared with the sensor head's (300) response to verify that the sensor head (300) is operating correctly. The standard (955) may be returned to a factory at periodic intervals for re-certification.

While the above has gone into a number of different elements that may be included in a flow cell (200) and sensing head (300) to provide for different types of measurement, it should be recognized that the above is by no means exhaustive and other types of sensors may be included in the flow cell (200) with a corresponding sensing head (300) that includes circuitry to read their output. This can include, but is not limited to, including a flow sensing element for monitoring fluid flow in the sample, a fluorescence sensing element for monitoring fluorescence in the process, a static mixer to mix individual constituents of the sample in the hollow interior (213), and/or a bubble or air sensor to monitor for bubbles in the sample.

The qualifier “generally,” and similar qualifiers as used in the present case, would be understood by one of ordinary skill in the art to accommodate recognizable attempts to conform a device to the qualified term, which may nevertheless fall short of doing so. This is because terms such as “circular” are purely geometric constructs and no real-world component or relationship is truly “circular” in the geometric sense. Variations from geometric and mathematical descriptions are unavoidable due to, among other things, manufacturing tolerances resulting in shape variations, defects and imperfections, non-uniform thermal expansion, and natural wear. Moreover, there exists for every object a level of magnification at which geometric and mathematical descriptors fail due to the nature of matter. One of ordinary skill would thus understand the term “generally” and relationships contemplated herein regardless of the inclusion of such qualifiers to include a range of variations from the literal geometric meaning of the term in view of these and other considerations.

While the invention has been disclosed in conjunction with a description of certain embodiments, including those that are currently believed to be useful embodiments, the detailed description is intended to be illustrative and should not be understood to limit the scope of the present disclosure. As would be understood by one of ordinary skill in the art, embodiments other than those described in detail herein are encompassed by the present invention. Modifications and variations of the described embodiments may be made without departing from the spirit and scope of the invention.

It will further be understood that any of the ranges, values, properties, or characteristics given for any single component of the present disclosure can be used interchangeably with any ranges, values, properties, or characteristics given for any of the other components of the disclosure, where compatible, to form an embodiment having defined values for each of the components, as given herein throughout. Further, ranges provided for a genus or a category can also be applied to species within the genus or members of the category unless otherwise noted.

1. A sensor system comprising:
a lower housing including a flow cell mount and a measurement photodiode;
a sensor head including a light source and an array of electrical contacts, said sensor head connected to said lower housing so as to provide a space between said lower housing and said sensor head; and
a flow cell, said flow cell positioned within said space between said sensor head and said lower housing, said flow cell attached to said flow cell mount and said flow cell including:
a generally hollow elongated main body including connectors arranged toward the opposing ends thereof, said connectors configured to interconnect with corresponding connectors in a process stream transport structure to allow at least a portion of a process stream to flow through said hollow interior;
a sensor chip which is in electrical contact with said electrical contacts in said sensor head; and
a light access comprising opposing windows which allow light from said light source to pass through said hollow interior and to said measurement photodiode.

2. The system of claim 1 further comprising: a pH probe electrically connected to said sensor head and mounted in a probe housing in said flow cell to detect pH in said hollow interior.

3. The system of claim 1 wherein said sensor chip includes sensors for measuring at least one of: conductivity, temperature, or pressure in said hollow interior.

4. The system of claim 1 wherein said light access is configured for absorption photometry in said hollow interior.

5. The system of claim 1 wherein said light access is configured for spectroscopy in said hollow interior.

6. The system of claim 1 wherein said light access is configured for front surface fluorescence.

7. The system of claim 6 wherein said windows are configured to be useable with a variety of optical path lengths varying from 0.5 mm to 100 mm.

8. The system of claim 7 wherein said windows are configured to be useable with a variety of optical path lengths varying from 0.5 mm to 60 mm.

9. The system of claim 8 wherein said windows are configured to be useable with a variety of optical path lengths varying from 0.5 mm to 50 mm.

10. The system of claim 9 wherein said windows are configured to be useable with a variety of optical path lengths varying from 0.5 mm to 10 mm.

11. The system of claim 6 wherein each of said windows in subdivided into a plurality of sub-windows.

12. The system of claim 11 wherein said sub-windows are arranged to provide for four separate light columns each having a different path length.

13. The system of claim 12 wherein said light paths have a length of about 0.25 mm, about 0.50 mm, about 1.00 mm, and about 2.00 mm.

14. The system of claim 1 wherein said flow cell mount comprises a rail and latch and said flow cell includes a groove for interacting with said rail and a pin for interacting with said latch.

15. The system of claim 1 wherein said lower housing includes a connector for a remote device.

16. The system of claim 15 wherein said remote device comprises a display.

17. The system of claim 15 wherein said remote device comprises a computer.

18. A sensor system comprising:
a lower housing including a flow cell mount and a measurement photodiode; and
a sensor head including a light source and an array of electrical contacts, said sensor head connected to said lower housing so as to provide a space between said lower housing and said sensor head;
wherein said lower housing and said sensor head are configured and positioned so a flow cell positioned within said space between said sensor head and said lower housing:
attaches to said flow cell mount; and
interconnects with a process stream transport structure to allow at least a portion of a process stream to flow through a hollow interior of said flow cell;
wherein said flow cell includes a sensor chip configured to interconnect to said electrical contacts in said sensor head; and
wherein light from said light source passes through said hollow interior and to said measurement photodiode.

19. A flow cell comprising:
a generally hollow elongated main body including connectors arranged toward the opposing ends thereof, said connectors configured to interconnect with corresponding connectors in a process stream transport structure to allow at least a portion of a process stream to flow through said hollow interior;
a sensor chip including electrical contacts for interconnecting with a sensor head; and
a light access comprising opposing two opposing windows, each of said opposing windows including multiple sub-windows and allowing light from said light source to pass through said hollow interior.

20. The flow cell of claim 19 wherein each of said sub-windows are arranged to provide for four separate light columns each having a different path length.
